(19) United States
(12) Patent Application Publication
(10) Pub. No.: US 2026/0177100 A1
(43) Pub. Date: Jun. 25, 2026

(54) BEARING UNIT

(71) Applicant: AKTIEBOLAGET SKF, GOTEBORG (SE)

(72) Inventors: Fabio BOGLIACINO, Corneliano d’Alba (IT); Riccardo NARDICCHIA, Torino (IT)

(21) Appl. No.: 19/422,567

(22) Filed: Dec. 17, 2025

(30) Foreign Application Priority Data
Dec. 24, 2024 (IT) 102024000029925

(51) Int. Cl. F16C 19/49; F16C 33/58; F16C 33/66

(52) U.S. Cl. CPC F16C 19/492; F16C 33/583; F16C 33/6637; F16C 2326/02

(57) ABSTRACT

A bearing unit has a central axis of rotation includes a radially outer ring having a sliding raceway, a radially inner ring having a sliding raceway, and a plurality of rolling bodies interposed between the radially outer ring and the radially inner ring to enable mutual rotation between the radially outer ring and the radially inner ring. A surface of the sliding raceway of the radially outer ring and/or a surface of the sliding raceway of the radially inner ring and/or a surface of one of the rolling bodies has a textured surface structure that includes micro alveoli divided by crests, and the micro alveoli are arranged along intersecting lines.

### CROSS-REFERENCE

This application claims priority to Italian patent application no. 102024000029925 filed on Dec. 24, 2024, the contents of which are fully incorporated herein by reference.

### TECHNOLOGICAL FIELD

The present disclosure relates to a bearing unit. More specifically, the present disclosure is directed to the field of automotives and, in particular, wheel hub assemblies, to which the following description will refer, by way of example, without this undermining its general applicability.

### BACKGROUND

Known wheel hub assemblies are mechanically interposed between a rotary element of the vehicle, for example a wheel, and a chassis of the motor vehicle. They generally includes an inner ring, an outer ring arranged coaxially and externally to the inner ring and two rows of rolling bodies interposed between the inner ring and the outer ring. An inner sliding raceway and an outer sliding raceway, both with an excellent surface finish, are formed, respectively, on the outside of the inner ring and on the inside of the outer ring in positions axially offset with respect to one another so as to allow the wheel hub assembly to support combined loads, in other words loads acting simultaneously in a radial direction and in an axial direction. Known wheel hub assemblies of the type described above further comprise a flanged hub, on which is formed an inner sliding raceway so as to define part of the inner ring, and an insert ring, which is fitted on a cylindrical end portion of the flanged hub, and is also provided with an inner sliding raceway so as to also define part of the inner ring.

Very briefly, bearing units for a wheel hub assembly, to which the present description will refer, are defined at least by the inner sliding raceways, by the outer sliding raceways and by the rows of rolling bodies, the reciprocal contact between them giving rise to both friction from rolling, and, although to a lesser degree, friction from rubbing. Even though the raceways and the rolling bodies have a very good surface finish, the grinding operations used to obtain this surface finish do however create, on the surface of the material, crests and valleys and, therefore, the surfaces in contact with one another give rise to non-negligible friction loss.

Friction losses have an effect on both the energy consumption of the motor vehicle, and, although indirectly, emissions that are harmful to the environment, such as, for example, carbon dioxide emissions.

With the increasingly strict environmental regulations that have come into effect in recent years, and in anticipation of even stricter environmental regulations to come, there is a need to develop increasingly sophisticated technological solutions aimed at reducing the abovementioned friction as far as possible, possibly focusing both on the sliding raceways and the rolling bodies, and on their lubrication.

### SUMMARY

It is an aspect of the present disclosure to provide a bearing unit which makes it possible to considerably reduce the friction generated by the reciprocal contact between the outer sliding raceways and the rolling bodies.

### BRIEF DESCRIPTION OF THE DRAWINGS

The disclosure will now be described with reference to the appended drawings, which illustrate a non-limiting embodiment of the disclosure, in which:

FIG. 1 is a cross section through a bearing unit according to a first embodiment of the present disclosure.

FIG. 2 is a cross section through a bearing unit according to a second embodiment of the present disclosure.

FIG. 3 is an enlarged view of a detail in FIG. 1.

FIG. 4 is an enlarged view of a detail in FIG. 3.

FIGS. 5A, 5B, 5C respectively depict embodiments of the surface finish of the detail in FIG. 3.

FIG. 6 shows a schematic, simplified view of a particular aspect of a technological process of machining of the detail in FIG. 4.

### DETAILED DESCRIPTION

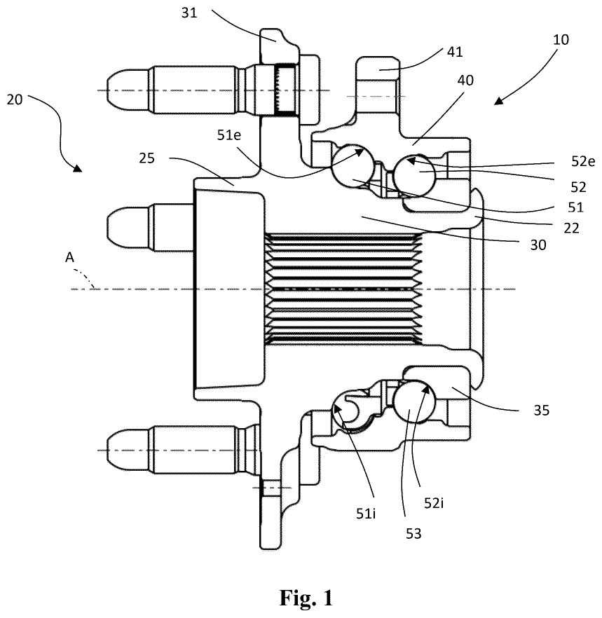

With reference to FIG. 1, the reference numeral 10 generally designates a bearing unit, in particular, a bearing unit 10 for a wheel hub assembly 20, to which the following description will refer, by way of example, without this undermining its general applicability.

The wheel hub assembly 20 is mechanically interposed between a rotary element of the motor vehicle, for example a wheel (not shown), and a chassis (not shown) of the vehicle, has a central axis A of rotation and symmetry, and includes an inner ring 30, an outer ring 40 arranged coaxially and externally to the inner ring 30, and two rows 51 and 52 of rolling bodies 53 (for example, balls, rollers or conical rollers) interposed between the inner ring and the outer ring. The rows of rolling bodies may be two adjacent ball rows, or two adjacent roller rows, or a ball row and an adjacent roller row.

The wheel hub assembly 20 further comprises, for each row 51 and 52 of rolling bodies, an inner sliding raceway 51i and 52i and an outer sliding raceway 51e and 52e formed, respectively, on the outside of the inner ring and on the inside of the outer ring in positions axially offset with respect to one another so as to allow the wheel hub assembly to support combined loads, in other words loads acting simultaneously in a radial direction and in an axial direction.

The wheel hub assembly further comprises a flanged hub 25, on which is formed the inner sliding raceway 51i so as to define part of the inner ring, and an insert ring 35, which is fitted on a cylindrical end portion 22 of the flanged hub 25, and is also provided with an inner sliding raceway 52i so as to also define part of the inner ring 30.

In the non-limiting example shown, the bearing unit 10 is a “third generation” bearing unit and therefore directly forms the entire wheel hub unit 20, in that the outer ring 40 comprises a flange 41, known, for attachment to the suspension upright (not shown for the sake of simplicity), formed in one piece with the outer ring 40, and in that the inner ring 30 comprises an attachment flange 31, known, for the wheel of the vehicle (not shown for the sake of simplicity) formed in one piece with the inner ring 30.

The bearing unit 10, according to the present disclosure and to which the present description will refer, is defined at least by the inner sliding raceways 51i, 52i, by the outer sliding raceways 51e, 52e and by the rows 51, 52 of rolling bodies 53. There may be, as in the preferred example of an embodiment shown, two rows of rolling bodies: however, the description below applies equally to the case in which there is a single row of rolling bodies, such as, for example, in some industrial applications for which the present disclosure may also be used. Moreover, in the current example of an embodiment shown in FIG. 1, the rolling bodies 53 of both the rows are represented by balls distributed uniformly around the axis A.

However, according to further preferred embodiments of the present disclosure, which have not been shown, but can be deduced easily from what is described, the rolling bodies of both the rows may be represented by rollers, which are also distributed uniformly around the axis A, or again, alternatively, the rolling bodies of one of the two rows may be represented by balls, and the rolling bodies of the other of the two rows may be represented by rollers.

This latter configuration is shown schematically in FIG. 2. With reference to the abovementioned FIG. 2, the reference numeral 10′ generally designates a bearing unit, in particular, a bearing unit 10′ for a wheel hub assembly 20′.

The wheel hub assembly 20′ is likewise mechanically interposed between a rotary element of the motor vehicle and a chassis of the vehicle, has a central axis A of rotation and symmetry, and comprises: an inner ring 30, an outer ring 40 arranged coaxially and externally to the inner ring 30, and a first row 51 of rolling bodies 53 (in this example, balls) and a second row 54 of rolling bodies 55 (in this example, conical rollers) interposed between the inner ring and the outer ring.

The wheel hub assembly 20′ further comprises, for each row 51 and 54 of rolling bodies, an inner sliding raceway 51i and 54i and an outer sliding raceway 51e and 54e formed, respectively, on the outside of the inner ring and on the inside of the outer ring in positions axially offset with respect to one another so as to allow the wheel hub assembly to support combined loads, in other words loads acting simultaneously in a radial direction and in an axial direction. In particular, the sliding raceways 54i, 54e for the conical rollers 55 are conical surfaces.

The wheel hub assembly further comprises a flanged hub 25, on which is formed the inner sliding raceway 51i so as to define part of the inner ring, and an insert ring 35, which is fitted on a cylindrical end portion 22 of the flanged hub 25, and is also provided with a conical inner sliding raceway 54i, so as to also define part of the inner ring 30. The insert ring 35 also has a conical guide surface 54a for the conical rollers 55.

The bearing unit 10′ according to the present disclosure is defined at least by the inner sliding raceways 51i, 54i, by the outer sliding raceways 51e, 54e and by the rows 51, 54 of rolling bodies 53, 55, which are respectively, as stated, balls and conical rollers.

Throughout the present description and in the claims, terms and expressions indicating positions and orientations, such as “radial” and “axial”, are to be understood with reference to the central axis of rotation A of the bearing unit 10, 10′. On the other hand, expressions such as “axially external” and “axially internal” refer to the wheel hub unit when mounted, and in this instance, preferably, refer to a wheel side and to a side opposite the wheel side, respectively.

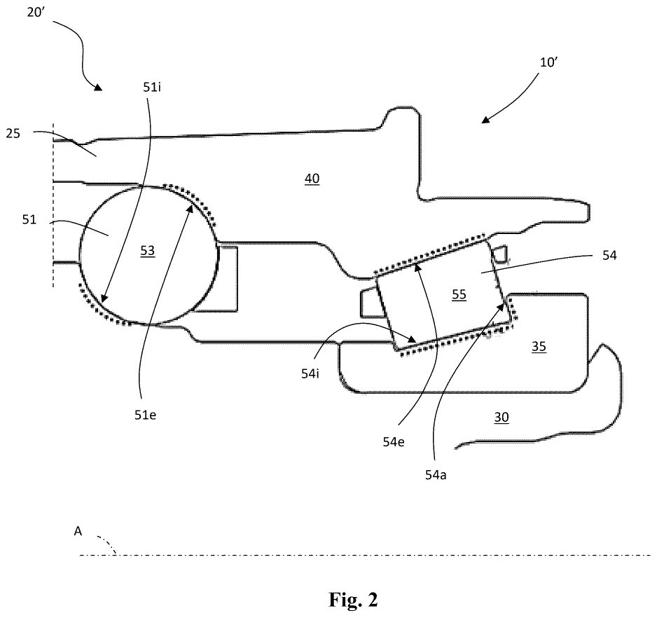

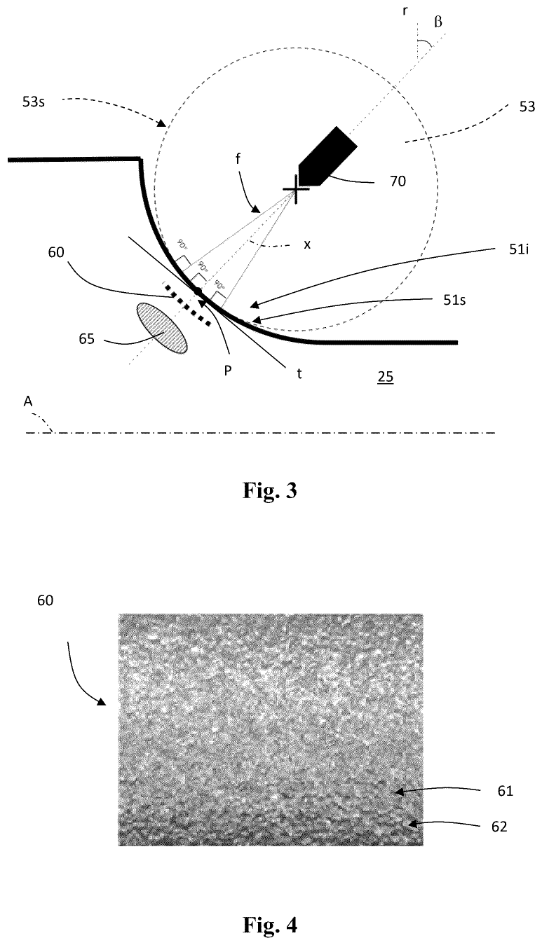

FIG. 3 shows an enlarged view in cross section of the inner sliding raceway 51i of the flanged hub 25 and a ball 53 in contact with the sliding raceway, but the description applies equally to the other three sliding raceways and to all the balls of the two rows of balls or to the balls of one row of rolling bodies and to the conical rollers of the second row of rolling bodies.

The inner sliding raceway 51i is delimited by a curved sliding surface 51s which extends around the axis A, while the ball 53 is externally delimited by a spherical outer surface 53s. The ball makes contact at points with the sliding raceway and as the load on the bearing unit increases, these points of contact become areas 65 of contact of elliptical shape.

However, in the case (not shown but still covered by the present disclosure) where the rolling bodies are rollers, or in the case, shown in FIG. 2, in which in one row of rolling bodies, the rolling bodies are conical rollers, these rolling bodies make linear contact with the sliding raceways which are not curved but instead are flat, in other words conical about the axis A, and, as the load on the bearing unit increases, these lines of contact become areas of contact of substantially rectangular shape.

The present disclosure aims to improve the performance of the bearing units 10, 10′ above all in terms of reducing the friction between specific coupling surfaces which contribute considerably to friction losses in bearing units, in particular, friction between the sliding raceways and the balls, friction between the sliding raceways and friction between the conical rollers, the guide surfaces and the conical rollers.

The features of the present disclosure will be described below with reference to the coupling between a sliding raceway and balls, without this undermining its general applicability, the features also being applicable to the other coupling surfaces.

According to the disclosure, therefore, the curved sliding surface 51s of the sliding raceway 51i, and, in combination, or, alternatively, the spherical outer surface 53s of the ball 53 comprise a controlled surface structure 60 formed, as will be described in more detail below and also with reference to FIG. 4, of a plurality of micro alveoli 61 (that is, small valleys) divided by crests 62, in which the micro alveoli and the crests are obtained by treatment using a laser source 70. The texturization of steel using a laser creates micro alveoli by a process called laser ablation. The laser beam removes the material which forms the micro alveoli from the surface of the metal (typically steel), with high accuracy, vaporizing the material. The high-energy laser pulses (or spots) f also give rise to plastic deformation, permanently modifying the surface when the laser energy exceeds the elastic limit of the material. Crests 62 are formed around the micro alveoli 61 as a result of the material shifted during the ablation process: material which is not vaporized is pushed to the sides, creating raised edges around the micro alveoli. The exact morphology of the texturized surface, including the presence of crests and the shape of the micro alveoli, depends on factors such as the power of the laser, the duration of the pulse and the properties of the metal from which the sliding raceways and rolling bodies are made. This process allows precise control over the consistency of the surface, significantly improving the tribological properties of the steel, such as reduction of friction and wear.

The controlled surface structure 60 of the sliding raceways and of the rolling bodies improves lubrication with a more robust presence of lubricant in the contact between the raceway of the rings and the rolling body: to be specific, the lubricant can accumulate right inside the micro alveoli 61. The surface structure 60 is formed of partially hemispherical micro alveoli 61 with a hemisphere diameter of between 30 μm and 100 μm. Advantageously, the surface structure 60 only covers part of the sliding surface 51s of the sliding raceway, whereas it is provided over the entire spherical outer surface 53s of the rolling bodies.

The dimensions and the spacing of the micro alveoli 61 can be controlled easily by laser. Advantageously, the dimension of the spot f may be likewise between 30 μm and 100 μm, while the minimum distance between the centers of the spots may be between 0.5 and 0.8 times the dimension of the spot.

The process required to create the controlled surface structure on the rolling bodies is slightly different, but yields comparable results. In particular, in the case of balls, a plurality of balls is placed in a sieve which rotates the balls randomly so as to expose the surface of the balls to the laser beam. Repeated exposure of the surface of the balls to the laser beam gives rise to the controlled surface structure. An alternative implementation of the process may apply in the case of rolling bodies in the form of rollers or conical rollers. The individual rolling body is moved by two horizontal rotating rollers which allow controlled rotation of the roller rolling body, which is thus exposed to the laser beam in a controlled manner.

In all instances, whether it is a case of sliding raceways, guide surfaces or rolling bodies, to ensure full treatment over their entire extent, the controlled surface structure 60 should have a coverage greater than or equal to 100%. Coverage of greater than 100% means that a previously treated surface portion is treated a second time, some degree of overlap being preferable to a process that leaves any untreated surface portion between two treated surface portions. The coverage that can be obtained with laser texturization depends on the dimension and the spacing of the spot f and is controlled with a high degree of accuracy.

The coverage of greater than or equal to 100% obtained by laser treatment is a very important feature since the controlled surface thus has overlapping micro alveoli and, therefore, does not have any flat areas between the various micro alveoli. The presence of flat areas is not desired since it increases the risk of rupture of the film of lubricant between the surfaces in contact, with a higher likelihood of metal-metal contact between the raceway and the rolling bodies.

Advantageously, the controlled surface structure 60 has an isotropic appearance.

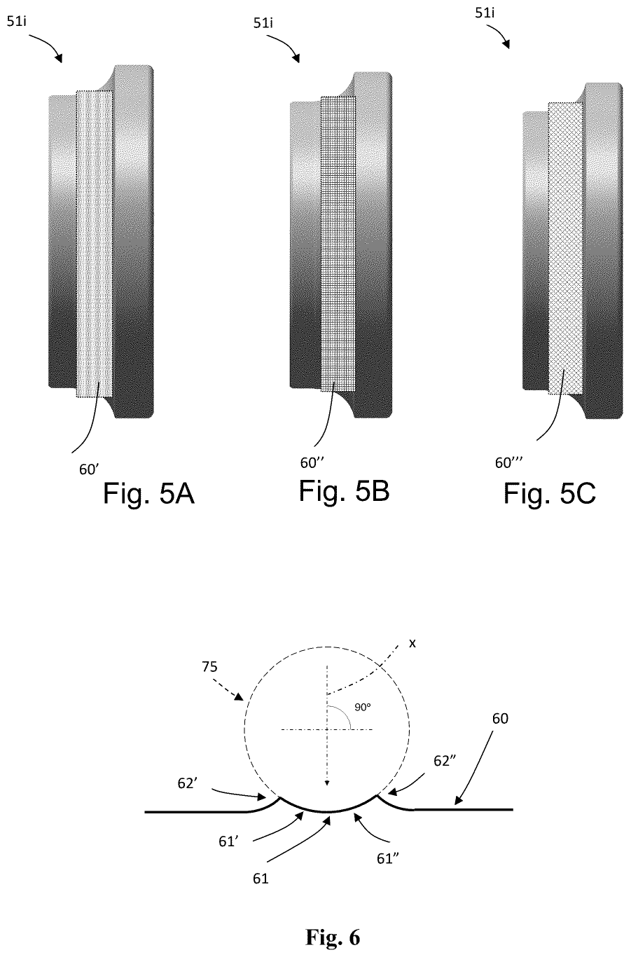

With reference to FIG. 5, a first embodiment (FIG. 5A) of the surface structure 60 has a punctiform texture 60′ obtained by applying individual random spots. This solution is technically feasible, but the cycle time may be very long owing to the limitations in terms of laser scanning speed.

Advantageously, an alternative technical solution is to generate controlled surface structures 60 in which the texture is formed of several micro alveoli positioned on intersecting lines such that there is no asymmetry when the rolling bodies are rolling in the circumferential direction. This prevents the generation of forces that could negatively affect friction in both directions of rotation (clockwise and anti-clockwise).

For example, a texture formed by means of several spots applied along intersecting lines may take the form of orthogonal textures 60″ with lines intersecting at 900 as in FIG. 5B, or diagonal textures 60′″ with lines intersecting at 450 as in FIG. 5C.

The above two solutions are preferable to using multiple random spots since the speed of the process is up to 20 times higher. This is due to the speed of scanning of the laser beam. When the speed of scanning across a line is compared to individual points using a laser source with a galvanometric head, the key factors are continuous movement, reduced inertia and optimization of the path. Line scanning allows the galvanometric head to move continuously along a predefined path, which is more efficient than stopping at each individual point and starting off again from each individual point. This reduces mechanical inertia and reduces to a minimum the distance that the laser has to travel, making the work quicker and more efficient.

The surface structures 60 of the sliding raceways and of the rolling bodies may be classified on the basis of roughness properties and other related geometric parameters.

Tables 1 and 2 below show, in Column 1, a list of roughness/geometric parameters of the controlled surface structure 60.

TABLE 1

| | | Raceways | | | |
|---|---|---|---|---|---|
| | STD | ablated by | | | |
| P | Raceways | laser | Delta | Comments | R |
| Rp | 0.228 | 0.687 | 201% | Maximum height of the crest of a | A |
| | | | | profile within the sampling length. | |
| | | | | The height of the crests increases | |
| | | | | owing to the deformation of material | |
| | | | | which conceals the grinding marks | |
| Ra | 0.095 | 0.232 | 145% | Arithmetic mean of the absolute | M |
| | | | | ordinate Z(x) within the sampling | |
| | | | | length. | |
| | | | | The mean roughness increases owing | |
| | | | | to an increase in Rp and Rv | |
| Rq | 0.161 | 0.310 | 93% | Root mean square value of Z(x) | B |
| | | | | within the sampling length. | |
| | | | | Similar to Ra, but provides a | |
| | | | | measurement of the dispersion of the | |
| | | | | heights of the bumps on the surface. | |
| | | | | Rq is generally more sensitive to the | |
| | | | | variations in height compared to Ra, | |
| | | | | since the greater deviations are | |
| | | | | amplified by the square. | |
| Rz | 1.166 | 1.998 | 71% | Sum of the maximum height of the | A |
| | | | | crest Zp and of the maximum depth | |
| | | | | of the valley Zv of a profile within | |
| | | | | the reference length. Laser ablation | |
| | | | | increases Rz as a result of the fact | |
| | | | | that the height Rp (crests) increases | |
| | | | | and Rv (valleys) increases. The | |
| | | | | height of the crests increases to a | |
| | | | | greater extent than the height of the | |
| | | | | valleys owing to the deformation of | |
| | | | | material. | |
| Rv | 0.938 | 1.305 | 39% | Maximum depth of the valley of a | A |
| | | | | profile within the sampling length. | |
| | | | | Laser ablation increases the depth of | |
| | | | | the valley. | |
| R Pc | 675.431 | 294.047 | −56% | Density of the crests (crests to the | A |
| | | | | cm). | |
| | | | | Laser ablation reduces the density of | |
| | | | | crests exceeding the threshold of Ra, | |
| | | | | reducing points of contact and | |
| | | | | making the surface more uniform | |
| | | | | than a surface not ablated by laser. | |

TABLE 2

| | | Raceways | | | |
|---|---|---|---|---|---|
| | STD | ablated by | | | |
| P | Raceways | laser | Delta | Comments | R |
| Rsk | −2.737 | −0.852 | −69% | Measurement of the mean of the first | A |
| | | | | derivative of the surface (the | |
| | | | | deviation of the surface from | |
| | | | | symmetry). A negative value of Rsk | |
| | | | | indicates that the surface is made up | |
| | | | | of valleys, while a surface with a | |
| | | | | positive skewness is deemed to | |
| | | | | contain mainly crests and bumps. | |
| | | | | After laser ablation, Rsk remains | |
| | | | | negative, indicating a greater | |
| | | | | presence of valleys than crests, | |
| | | | | which will guarantee good | |
| | | | | lubrication | |
| RSm | 127.000 | 35.000 | −73% | Mean for the length Xs of the | A |
| | | | | elements of the profile within the | |
| | | | | sampling length. | |
| | | | | With a diameter of from 30 to | |
| | | | | 100 μm, the laser spots successfully | |
| | | | | penetrate into the valleys of the | |
| | | | | surface not treated, which has a | |
| | | | | width of approximately 65 microns. | |
| | | | | The distance Xs of the surface | |
| | | | | treated is thus reduced to 35 microns | |
| | | | | by virtue of a coverage of the surface | |
| | | | | of greater than 100% | |
| Rku | 19.289 | 4.999 | −74% | The quotient of the mean square | A |
| | | | | value of Z(x) and the fourth power of | |
| | | | | Rq within a sampling length. Rku is | |
| | | | | reduced with treatment by laser | |
| | | | | ablation, rendering the geometry of | |
| | | | | the valleys and the crests less sharp. | |
| Rdq | 3.6 | 4.83 | 34% | Local slope (dz/dx) of the crests. | M |
| | | | | This is the parameter most correlated | |
| | | | | with the angle of the edge of the | |
| | | | | original alveoli. It represents the | |
| | | | | inclination of the bumps (dz/dx) and, | |
| | | | | since it is constant in all directions, | |
| | | | | confirms that the surface structure is | |
| | | | | isotropic. | |

For each parameter, Tables 1 and 2 provide:
in Column 2, the corresponding value of the parameter for standard raceways,
in Column 3, the corresponding value of the parameter for laser treated raceways,
in Column 4, the percentage variation (D %) of the parameter owing to the laser treatment,
in Column 5, the technical characteristics of the roughness/geometric parameters, and
in Column 6, the relevance “R” (A: high; M: medium; B: low), in other words the importance of the roughness/geometric parameter for obtaining the reduction in friction.

Laser treatment therefore comprises an increase in roughness values, for example Rp, Rz, and Rv. In other words, the laser ablation process, by creating so many micro alveoli, has the effect of modifying the profile of crests and valleys resulting from the preceding grinding operations, smoothing out the crests and increasing the depth and the extent of the valleys. Therefore, the number of crests after laser treatment will be lower but they will have a more extensive surface area. The spots from the laser source strike and plastically deform both the material at the top of the crests and the material between adjacent crests and thus give rise to micro alveoli with dimensions of the same order of magnitude as the dimensions of the laser spots.

All of this in turn leads to a more robust presence of lubricant and a reduction in wear. More particularly, the increase in the roughness Rp is due to the fact that the height of the crests increases as a result of the deformation of material which, therefore, will conceal the crests resulting from the preceding grinding operation. In addition, the increase in the roughness Rv is due to the fact that the laser ablation operation increases the depth of the micro alveoli, and the mean roughness Ra increases by virtue of the increase in the roughness Rp and Rv. Furthermore, the roughness Rq is similar to the roughness Ra, but in addition also provides a more accurate measurement of the dispersion of the heights of the crests and of the micro alveoli. To be specific, the roughness Rq is generally more sensitive to the variations in the heights of the crests and the depths of the micro alveoli than the roughness Ra, since the greater deviations are further amplified by the square included in the formula for calculating the roughness Rq,

The roughness Rz increases by virtue of the fact that both the roughness values Rp and the roughness values Rv increase. Note that the height of the crests increases more than the depth of the micro alveoli owing to the deformation of the material. Also, the density of the crests having a height greater than the roughness value Ra falls as a result of the laser treatment. This makes the surface of the sliding raceway (or of the rolling body) more uniform. The asymmetry value (or “skewness”) Rsk after laser ablation decreases and remains (or becomes) negative, indicating a greater presence of micro alveoli than crests. This gives a greater guarantee of good lubrication.

The parameter RSm falls for the following reason. The dimension of the spots of the laser source ranges from 30 to 100 μm. These spots successfully penetrate the valleys of the surface not treated, which have a dimension of around 65 μm. The distance Xs of the treated surface is reduced to 35 μm by virtue of a coverage of the surface structure greater than or equal to 100%. The parameter Rku falls after laser treatment and this means that the geometry of the micro alveoli and of the crests is less peaked, and the parameter Rdq is correlated with the angle of the edge of the original alveoli. It represents the inclination of the crests (dz/dx) and, since it is constant in all directions, confirms that the surface structure is isotropic.

Therefore, on the basis of the above findings, ranges for the roughness values and the geometric parameters analyzed have been defined accordingly, as shown in Table 3:

TABLE 3

| | |
|---|---|
| μm | μm |

| Rp | 0.5 | μm | 0.8 | μm |
|---|---|---|---|---|
| Rv | 0.9 | μm | 1.5 | μm |
| Ra | 0.12 | μm | 0.5 | μm |
| Rq | 0.15 | μm | 0.4 | μm |
| Rz | 1.4 | μm | 2.2 | μm |
| RPc | 200 | peaks/cm | 550 | peaks/cm |
| Rsk | −1.5 | | 0.6 | |
| RSm | 15 | μm | 50 | μm |

| | | |
|---|---|---|
| Rku | 3 | 6.5 |
| Rdq | 3.2 | 5.8 |

The roughness value Rku, also referred to as kurtosis, of between 3 and 6.5, is an essential parameter for obtaining more uniform crests and valleys of the surface micro alveoli on the roller bearings. This range reduces the likelihood of metal-metal contact owing to the softer shape of the crests. When combined with a greater valley depth (Rv), of from 0.9 to 1.5, this facilitates better retention and recirculation of the lubricant within the area of contact, preventing the lubricant from being trapped in deep valleys.

Moreover, a slightly negative asymmetry value (Rsk), of approximately −0.8, indicates a predominance of valleys with respect to crests, valleys which act as reservoirs for the lubrication grease. This reservoir effect is fundamental for maintaining an adequate film of lubricant, which considerably reduces friction and wear.

Generating less friction is further enhanced by a smaller mean spacing of surface irregularities (Rsm) of between 15 and 50 μm. This shorter distance between crests and valleys minimizes the presence of large bumps, which otherwise could give rise to resistance during movement.

The ranges of the roughness values and of the geometric parameters as defined in Table 3 may be considered optimal for obtaining the technical effect of the present disclosure. It is however possible, on the basis of experimentation, to define slightly broader ranges also making it possible to obtain the desired technical effect. These ranges are given in Table 4 below.

TABLE 4

| | |
|---|---|
| μm | μm |

| Rp | 0.4 | μm | 0.98 | μm |
|---|---|---|---|---|
| Rv | 0.9 | μm | 2.4 | μm |
| Ra | 0.12 | μm | 0.5 | μm |
| Rq | 0.15 | μm | 0.49 | μm |
| Rz | 1.4 | μm | 3.5 | μm |
| RPc | 100 | peaks/cm | 700 | peaks/cm |
| Rsk | −3.3 | | 0.6 | |
| RSm | 15 | μm | 120 | μm |

| | | |
|---|---|---|
| Rku | 3 | 24 |
| Rdq | 3.2 | 5.9 |

A further indication of how the state of the surface structure ensures performance with reduced friction may be obtained from an analysis of the Abbott curve as defined by the standard DIN 4776 or ISO 13565 (e.g., ISO 13565-1:1996). The Abbott curve or material ratio curve best describes the distribution of peaks and valleys along the profile analyzed during the measurement of roughness. The Abbott curve therefore best sums up the characteristics of the surface structure, incorporating the roughness values give above. Experimental tests have established that sliding raceways having the controlled surface structure according to the disclosure initially have a percentage of peaks of 10%, while the percentage of valleys is 20%. After a run-in test of around 30 minutes, the percentage of peaks falls to 1% while the percentage of valleys remains constant at 20%. Therefore, the surface structure obtained has a prevalence of valleys which represents the best configuration for maintenance and adhesion of the film of lubricant. Moreover, the fall in the percentage of peaks limits the chance of unwanted friction occurring.

Again with reference to FIG. 3 and the sliding raceway 51i, it is also preferable for the axis x of the spot beam f emitted by the laser source 70 to be orthogonal to the tangent t to the surface 51s to be treated at the point P of impact of the beam f on the surface 51s. Thus, the micro alveoli 61 are symmetrical about the point P of impact of the beam f.

FIG. 6 shows a micro alveolus 61 formed by virtue of the impact of a spot 75 of the spot beam f having as axis of impact the axis x as defined above, in other words orthogonal to the surface to be treated. The symmetry of the alveolus 61 is demonstrated by the equal nature of the two portions 61′ and 61″ of the micro alveolus 61 on either side of the axis x, and by the equal nature of the two crests 62′, 62″, which are almost semicircular, also on either side of the axis x.

Moreover, the non-treated surfaces of the sliding raceways relating to the various rings of the bearing unit (axially outer inner ring, axially inner inner ring, axially outer outer ring and axially inner outer ring) have significant variations in various roughness parameters (depending on the ring in question) with a Standard Deviation/Mean of around 22.3%. In the treated surfaces, however, this Standard Deviation/Mean value, considering more roughness parameters, falls to 6.4%. As a result of this finding, the treated surfaces of the sliding raceways 51i, 52i, 51e, 52e, 54i, 54e are uniform across the board compared to the corresponding non-treated surfaces.

Advantageously, the point P of impact of the beam f coincides with the point of contact between the sliding raceway and the rolling bodies. Moreover, the tangent to the sliding raceway and rolling bodies at the point of contact coincides with the tangent t to the surface 51s to be treated and the axis x of the spot beam f emitted by the laser source 70 coincides with the straight line perpendicular to the sliding raceways and rolling bodies at the point of contact. In this way, it is possible to minimize the extent of the surface structure 60 to be treated, obtaining better properties of the structure where it occurs.

The above-described process used to generate the controlled surface structure may be the last operation, coming after the operation of polishing the sliding raceways or skipping the polishing process and applying it directly to the ground sliding raceways. Eliminating the polishing process has benefits in terms of production costs. Moreover, by applying the laser ablation process, any circular or elliptical marks left over from the machining processes, such as turning and/or grinding, are virtually eliminated or limited.

The controlled surface structure 60 may be created only on the rolling bodies, or only on the sliding raceways, or on both. The rolling bodies may be balls, cylindrical rollers or conical rollers.

Advantageously, the surface structure 60 may be subjected to a successive process of tribological oxidation, for example, using oxidizing agents such as alkali nitrite or alkali nitrate. The layer of iron oxide comprises at least 99% by weight of iron oxide in the form of a compound structure having the molecular formula Fe₃O₄ and a maximum of 0.5% by weight of free iron oxide having the molecular formula Fe₂O₃. This enhances the surface adhesion of the lubricant and the high frequency ripple of the rolling bodies (<200 μm/s) with the consequent reduction of noise in the bearings, especially in the high frequency band between 700 and 4000 Hz (with the bearing rotating at 700 rpm).

According to another aspect of the present disclosure, the controlled surface structure 60 may advantageously be combined with a lubricant having the following characteristics: a base oil selected from synthetic oils and/or Poly-Alpha-Olefin (PAO) oils, a viscosity of the base oil between 25-120 mm²/s at 40° C. (DIN 51562) and between 5-20 mm²/s at 100° C. (DIN 51562), and a thickener selected from a lithium complex, a calcium complex, or Poly-urea.

To be specific, using a lubricant having a low viscosity and therefore greater fluidity means that the alveoli present on the surface are filled more completely and more uniformly, and creates a layer of lubricant between the surfaces in contact which is more robust and more stable.

To sum up, the present disclosure affords the following advantages for the bearing unit: a reduction in friction torque, a reduction in or elimination of any difference in the effects of friction between the clockwise and anticlockwise directions, a reduction in noise, a improvement in fatigue life, enhanced lubrication conditions, texturization applied to selected areas, with precision, in such a way as to maximize efficiency in terms of time and energy, coverage of the selected areas may be controlled precisely with the desired percentage, the main dimensions of the micro alveoli, their distance and their positions are also controlled precisely by the laser, there is no need for cleaning or polishing after the laser treatment and no use of consumable or wearable materials, and the form taken by the texturization may be adjusted easily using laser control software and may be adaptable and usable.

In addition to the embodiment of the disclosure as described above, it will be appreciated that there are numerous other variants. It will also be appreciated that the embodiments are merely examples and do not limit the scope of the disclosure, its applications, or its possible configurations. On the contrary, while the above description enables those skilled in the art to apply the present disclosure according to at least one example of an embodiment, it will be appreciated that many variations of the components described may be devised, without thereby departing from the scope of the disclosure as defined in the appended claims, interpreted literally and/or according to their legal equivalents.

What is claimed is:

1. A bearing unit having a central rotation axis and comprising:
a radially outer ring having a sliding raceway,
a radially inner ring having a sliding raceway, and
a plurality of rolling bodies interposed between the radially outer ring and the radially inner ring to enable mutual rotation between the radially outer ring and the radially inner ring,
wherein a surface of the sliding raceway of the radially outer ring and/or a surface of the sliding raceway of the radially inner ring and/or a surface of one of the rolling bodies has a textured surface structure comprising micro alveoli divided by crests, and
wherein the micro alveoli are arranged along intersecting lines.

2. The bearing unit according to claim 1,
wherein the surface of the sliding raceway of the radially inner ring includes the textured surface structure and the textured surface structure of the sliding raceway of the radially inner ring forms a continuous annular band on the sliding raceway of the radially inner ring, and/or
wherein the surface of the sliding raceway of the radially outer ring includes the textured surface structure and the textured surface structure of the sliding raceway of the radially outer ring forms a continuous annular band on the sliding raceway of the radially outer ring.

3. The bearing unit according to claim 2,
wherein the intersecting lines are mutually orthogonal.

4. The bearing unit according to claim 2,
wherein the intersecting lines form an angle of 45°.

5. The bearing unit according to claim 1,
wherein the radially inner ring comprises an insert ring, and
wherein a conical guide surface of the insert ring includes the textured surface structure.

6. The bearing unit according to claim 1,
wherein a maximum height (Rp) of the crests is between 0.5 μm and 0.8 μm.

7. The baring unit according to claim 1,
wherein a maximum depth (Rv) of the micro alveoli is between 0.9 μm and 1.5 μm.

8. The bearing unit according to claim 1,
wherein an average width (RSm) of the profile elements of the micro alveoli is between 15 μm and 50 μm.

9. The bearing unit according to claim 1,
wherein a density (RPc) of the crests is between 200 crests/cm and 550 crests/cm.

10. The bearing unit according to claim 1,
wherein an asymmetry (Rsk) of the surface structure is between −1.5 and 0.6.

11. The bearing unit according to claim 1,
wherein an inclination (Rdq) of the crests along any direction is between 3.2 and 5.8.

12. The bearing unit according to claim 1,
wherein a maximum height (Rp) of the crests is between 0.5 μm and 0.8 μm,
wherein a maximum depth (Rv) of the micro alveoli is between 0.9 μm and 1.5 μm,
wherein an average width (RSm) of the profile elements of the micro alveoli is between 15 μm and 50 μm,
wherein a density (RPc) of the crests is between 200 crests/cm and 550 crests/cm,
wherein an asymmetry (Rsk) of the surface structure is between −1.5 and 0.6, and
wherein an inclination (Rdq) of the crests along any direction is between 3.2 and 5.8.

13. The bearing unit according to claim 12,
including a lubricant comprising a base oil, the base oil comprising a synthetic oil and/or a Poly-Alpha-Olefin (PAO) oil,
wherein a viscosity of the base oil is between 25-120 mm²/s at 40° C. (DIN 51562) and between 5-20 mm²/s at 100° C. (DIN 51562),
wherein the lubricant includes a thickener comprising a lithium complex, a calcium complex or Poly-urea.

14. The bearing unit according to claim 1,
including a lubricant comprising a base oil, the base oil comprising a synthetic oil and/or a Poly-Alpha-Olefin (PAO) oil,
wherein a viscosity of the base oil is between 25-120 mm²/s at 40° C. (DIN 51562) and between 5-20 mm²/s at 100° C. (DIN 51562),
wherein the lubricant includes a thickener comprising a lithium complex, a calcium complex or Poly-urea.

15. A wheel hub assembly comprising a bearing unit according to claim 1.

16. A wheel hub assembly comprising:
a bearing unit having a central rotation axis and comprising:
a radially outer ring having a first sliding raceway and a second sliding raceway,
a radially inner ring comprising a first inner ring element having a first sliding raceway, the first inner ring element being mounted on a second inner ring element, the second inner ring element having a second sliding raceway, and
a first plurality of rolling bodies between the first sliding raceway of the radially outer ring and the first sliding raceway of the radially inner ring and a second plurality of rolling bodies between the second sliding raceway of the radially outer ring and the second sliding raceway of the radially inner ring,
wherein a surface of the first and/or second sliding raceway of the radially outer ring and/or a surface of the first and/or second sliding raceway of the radially inner ring and/or a surface of one of the first plurality of rolling bodies and/or a surface of one of the second plurality of rolling bodies has a textured surface structure comprising micro alveoli divided by crests, and
wherein the micro alveoli are arranged along intersecting lines.
